(19) United States
(12) Patent Application Publication
(10) Pub. No.: US 2022/0048291 A1
(43) Pub. Date: Feb. 17, 2022

(54) SENSOR SIGNAL ENCODED VIA MODULATED MECHANICAL INTERACTION WITH SENSOR(S)

(71) Applicant: Hewlett-Packard Development Company, L.P., Spring, TX (US)

(72) Inventors: Eric T. Martin, Corvallis, OR (US); Daryl E. Anderson, Corvallis, OR (US)

(73) Assignee: Hewlett-Packard Development Company, L.P., Spring, TX (US)

(21) Appl. No.: 17/311,829

(22) PCT Filed: Apr. 29, 2019
(86) PCT No.: PCT/US2019/029621

§ 371 Date: Jun. 8, 2021

(51) Int. Cl. B41J 2/165

(52) U.S. Cl. CPC B41J 2/16538; B41J 2/16585; B41J 2/16508

(57) ABSTRACT

In various examples, a fluid ejection die, or a device such as a printhead or printbar on which the fluid ejection device is installed, may include a sensor that detects mechanical force imposed by a system in which the fluid ejection die is installed. There also may be memory, as well as a logic operably coupled with the sensor and the memory. The logic may extract information from a signal raised by the sensor and store the information in the memory. The information may have been encoded into the signal via mechanical interaction between a component of the system and the sensor. The mechanical interaction may have been modulated by the system to encode the information.

### BACKGROUND

Printers communicate various information to printheads and/or individual printhead die that is used for various purposes, such as controlling the printhead, monitoring printhead operation, etc. For example, printhead operation may be monitored to ensure high print quality and/or to protect the print system from possible damage that could result from an improperly-operating printhead.

### BRIEF DESCRIPTION OF THE DRAWINGS

Features of the present disclosure are illustrated by way of example and not limited in the following figure(s), in which like numerals indicate like elements.

FIG. 1 is a drawing of an example printing press that uses fluid ejection devices such as printheads to form images on a print medium.

FIG. 2 is a block diagram of an example of an ink jet printing system that may be used to form images using ink jet printheads.

FIG. 3 is a drawing of a cluster of ink jet printheads in an example print configuration, for example, in a printbar.

FIG. 4A depicts an example of a fluid ejection device equipped with a fluid ejection die configured with selected aspects of the present disclosure.

FIG. 4B depicts another example of a fluid ejection device equipped with a fluid ejection die configured with selected aspects of the present disclosure.

FIG. 5 schematically depicts an example exchange of data between a fluid ejection die and a fluid ejection system in which the fluid ejection die is installed.

FIG. 6 depicts an example method of practicing selected aspects of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, it should be understood that the elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

Examples are described herein that relate to encoding fluid ejection components such as printheads, printhead die, printbars, etc., with information by modulating mechanical interaction with the fluid ejection components in a manner dictated by the desired information. This modulation is captured by sensor(s) of the fluid ejection component and encoded into signals raised by those sensors. For example, strain sensor(s) have recently been incorporated into printheads for a variety of purposes. Printhead wiping operations, which nominally are meant to clean printhead nozzles, may be modulated in order to convey information that is captured by the strain sensor(s). Various types of mechanical interaction may be modulated to convey the information. For example, a predetermined sequence of multiple strain sensors could be triggered, or a direction/speed/pressure of wiping could be used to convey information.

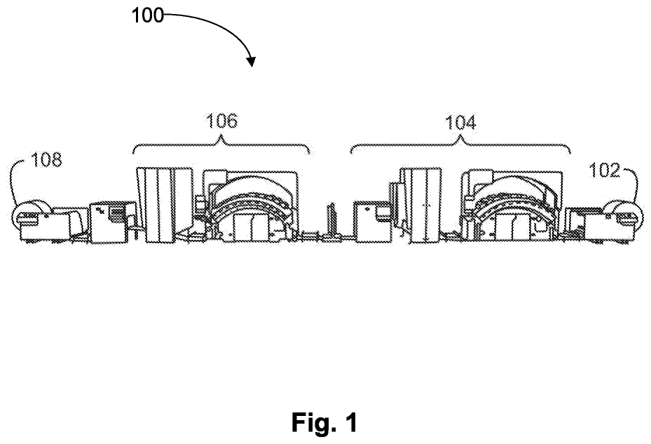

FIG. 1 is a drawing of a non-limiting example of a printing press 100 that uses ink jet printheads to form images on a print medium. The printing press 100 can feed a continuous sheet of a print medium from a large roll 102. The print medium can be fed through a number of printing systems, such as printing system 104. In the printing system 104 a printbar that houses a number of printheads ejects ink droplets onto the print medium. A second printing system 106 may be used to print additional colors. For example, the first system 104 may print black, while the second system 106 may print cyan, magenta, and yellow (CMY).

The printing systems 104 and 106 are not limited to two, or the mentioned color combinations, as any number of systems may be used, depending, for example, on the colors desired and the speed of the printing press 100. Moreover, techniques described herein are not limited to printing presses such as that depicted in FIG. 1. Techniques described herein can be implemented in a wide variety of scenarios, such as in desktop printers, end-of-aisle printers, a printhead with a single die, thermal inject printers, piezo inkjet printers, etc. Moreover, techniques described herein may apply to systems with a fixed printhead and/or printbar and moving media, and/or to systems with scanning printheads and/or bars. In addition, techniques described herein are applicable with both two-dimensional (“2D”) and three-dimensional (“3D”) printers.

After the second system 106, the printed print medium may be taken up on a take-up roll 108 for later processing. In some examples, other units may replace the take-up roll 108, such as a sheet cutter and binder, among others. The printing press of FIG. 1 is provided as a non-limiting example. Other fluid ejection systems are contemplated herein.

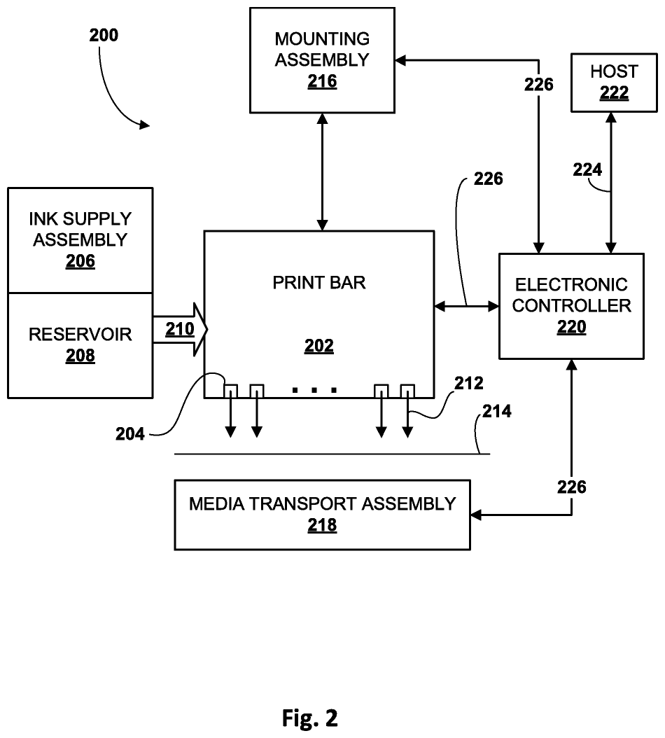

FIG. 2 is a block diagram of an example of an ink jet printing system 200 that may be used to form images using ink jet printheads. The ink jet printing system 200 includes a printbar 202, which includes a number of printheads 204, and an ink supply assembly 206. The ink supply assembly 206 includes an ink reservoir 208. From the ink reservoir 208, ink 210 is provided to the printbar 202 to be fed to the printheads 204. The ink supply assembly 206 and printbar 202 may use a one-way ink delivery system or a recirculating ink delivery system. In a one-way ink delivery system, substantially all of the ink supplied to the printbar 202 is consumed during printing. In a recirculating ink delivery system, a portion of the ink 210 supplied to the printbar 202 is consumed during printing, and another portion of the ink is returned to ink supply assembly 206. In an example, the ink supply assembly 206 is separate from the printbar 202, and supplies the ink 210 to the printbar 202 through a tubular connection, such as a supply tube (not shown). In other examples, the printbar 202 may include the ink supply assembly 206, and ink reservoir 208, along with a printhead 204, for example, in single user printers. In either example, the ink reservoir 208 of the ink supply assembly 206 may be removed and replaced, or refilled.

From the printheads 204 the ink 210 is ejected from nozzles as ink droplets 212 towards a print medium 214, such as paper, Mylar, cardstock, and the like. The nozzles of the printheads 204 are arranged in columns or arrays such that properly sequenced ejection of ink 210 can form characters, symbols, graphics, or other images to be printed on the print medium 214 as the printbar 202 and print medium 214 are moved relative to each other. The ink 210 is not limited to colored liquids used to form visible images on a print medium, for example, the ink 210 may be an electro-active substance used to print circuit patterns, such as solar cells.

A mounting assembly 216 may be used to position the printbar 202 relative to the print medium 214. In an example, the mounting assembly 216 may be in a fixed position, holding a number of printheads 204 above the print medium 214. In another example, the mounting assembly 216 may include a motor that moves the printbar 202 back and forth across the print medium 214, for example, if the printbar 202 included one to four printheads 204. A media transport assembly 218 moves the print medium 214 relative to the printbar, for example, moving the print medium 214 perpendicular to the printbar 202. In the example of FIG. 1, the media transport assembly 218 may include the rolls 102 and 108, as well as any number of motorized pinch rolls used to pull the print medium through the printing systems 104 and 106. If the printbar 202 is moved, the media transport assembly 218 may index the print medium 214 to new positions. In examples in which the printbar 202 is not moved, the motion of the print medium 214 may be continuous.

An electronic controller 220 receives data from a host system 222, such as a computer. The data may be transmitted over a network connection 224, which may be an electrical connection, an optical fiber connection, or a wireless connection, among others. The data may include a document or file to be printed, or may include more elemental items, such as a color plane of a document or a rasterized document. The electronic controller 220 may temporarily store the data in a local memory for analysis. The analysis may include determining timing control for the ejection of ink drops from the printheads 204, as well as the motion of the print medium 214 and any motion of the printbar 202. The electronic controller 220 may operate the individual parts of the printing system over control lines 226. Accordingly, the electronic controller 220 defines a pattern of ejected ink drops 212 which form characters, symbols, graphics, or other images on the print medium 214. Electronic controller 220 may take various forms, such as a field-programmable gate array (“FPGA”), an application-specific integrated circuit (“ASIC”), or a processor that executes instructions stored in memory.

The ink jet printing system 200 is not limited to the items shown in FIG. 2. For example, the electronic controller 220 may be a cluster computing system coupled in a network that has separate computing controls for individual parts of the system. For example, a separate controller may be associated with each of the mounting assembly 216, the printbar 202, the ink supply assembly 206, and the media transport assembly 218. In this example, the control lines 226 may be network connections coupling the separate controllers into a single network. In other example, the mounting assembly 216 may not be a separate item from the printbar 202, for example, if no motion is needed by the printbar 202.

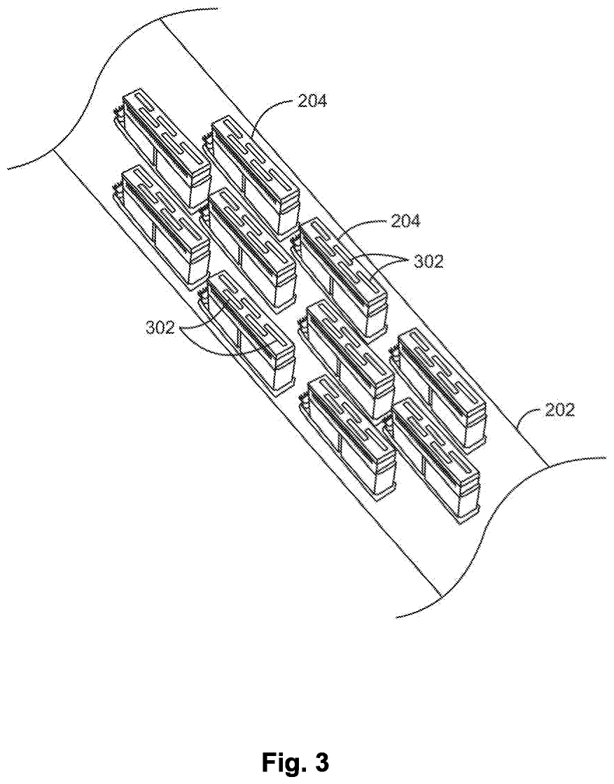

FIG. 3 is a drawing of a cluster of ink jet printheads 204 in an example print configuration, for example, in a printbar 202. Like numbered items are as described with respect to FIG. 2. The printbar 202 shown in FIG. 3 may be used in configurations that do not move the printhead. Accordingly, the printheads 204 may be attached to the printbar 202 in an overlapping configuration to give complete coverage. In this example, each printhead 204 has multiple fluid ejection dies 302 (also referred to as “printhead dies”) that have the nozzles and circuitry used to eject ink droplets. In various examples, the fluid ejection die 302 may or may not be constructed with materials such as silicon. The sensors (e.g., 450 below) described herein may be disposed (e.g., embedded in), among other places, on these individual fluid ejection dies 302.

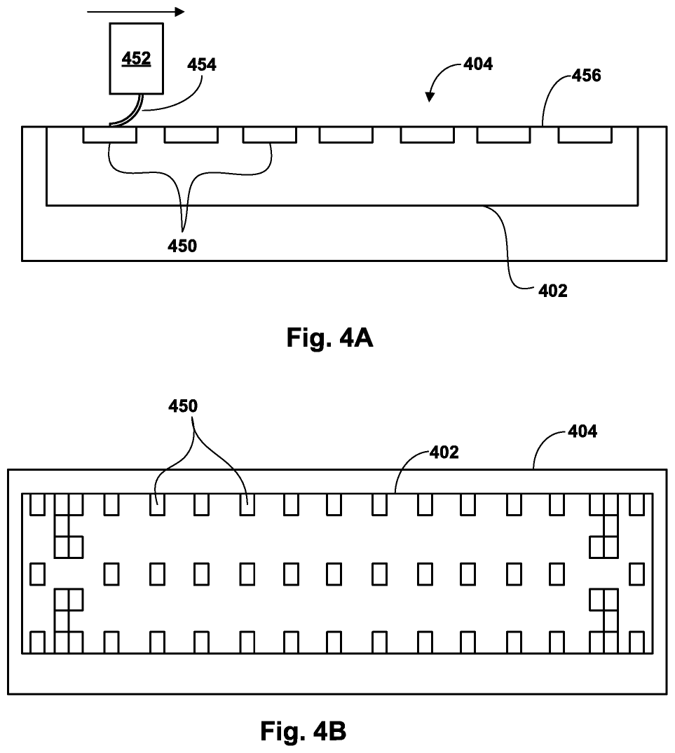

FIG. 4A schematically depicts a fluid ejection device 404, which may or may not correspond to an ink printhead 204 of previous figures. Fluid ejection device 404 may include a fluid ejection die 402, and as shown in FIG. 3 may in some cases include multiple fluid ejection dies. Fluid ejection die 402 may include a plurality of nozzles (not depicted) for ejecting fluids such as ink towards print medium 214, i.e. in the upward direction in FIG. 4A. Fluid ejection die 402 also includes an array of sensors 450 disposed at various locations across its dimension(s). Sensors 450 may take various forms in various examples. In some examples, sensors 450 may include pressure sensors. In some examples, sensors 450 may include piezoelectric sensors.

In some examples, sensors 450 may take the form of strain sensors (or strain “gauges”) that measure strain imparted on or otherwise experienced by an object, in this case, fluid ejection die 402. In some examples, a strain sensor may include an insulating flexible backing that supports a metallic foil pattern. The backing is attached to an object such as fluid ejection die 402 and/or using various adhesives. When the object is deformed mechanically, the metallic foil is likewise deformed, which alters its electrical resistance. This change in electrical resistance can be detected, e.g., using a Wheatstone bridge, and may be related to the strain by a quantity such as a gauge factor. Put another way, a strain sensor converts force, pressure, tension, and/or weight imparted on and/or experienced by fluid ejection die 402 into a measureable change in electrical resistance.

In other examples, strain sensor(s) may be integrated into fluid ejection die 402. For example, diffusion regions of a silicon-based fluid ejection die 402 may be used to form resistors that are integrated into different orientations with respect to a silicon crystalline lattice structure of fluid ejection die 402. Consequently, as the lattice structure is deformed due to strain, the resistances of the various diffusion resistors may change. By measuring the resistance—and more particularly the differential resistance—between resistors of varying orientations, strain information can be inferred. In some such examples, the diffusion resistors may be implemented similarly to a Wheatstone bridge.

FIG. 4A also depicts a mechanical component in the form of a servicing mechanism 452 that may be operable to cause and/or modulate physical contact with sensor(s) 450. In examples described herein, servicing mechanism 452 includes a wiper 454 (e.g., a rubber strip) as depicted in FIG. 4A that can be brought into physical contact with a surface 456 of fluid ejection die 402. In some examples, servicing mechanism 452 may additionally or alternatively be configured to bring fluid ejection device 404 into contact with an absorbent material, e.g., forming part of rolls 102 and 108 in FIG. 1, to clean off ink or other fluids. In some examples, fluid ejection device 404 may include a “printhead cap” that contacts surface 456, e.g., to seal off nozzles when not in use.

In various examples, servicing mechanism 452 may be part of a “service station” of ink jet printing system 200. In some examples, servicing mechanism 452 may include a motor or other similar means for causing wiper 454 to be brought into contact with surface 456. A service station may perform various maintenance-related tasks, such as cleaning ink off printheads, aligning/realigning print components, etc. Servicing mechanism 452 may be operated to drag wiper 454 across surface 456 to remove ink or other fluids from fluid ejection die 402.

While examples described herein primarily focus on modulation of mechanical interaction between wiper 454 and sensor(s) 450 to encode information, mechanical operation of any of these potential components of servicing mechanism 452 may be modulated in order to encode information. And in some examples, a mechanical component may be operable solely to cause modulated mechanical interaction between a printing system and a component installed therein.

The physical contact with sensor(s) 450 caused by servicing mechanism 452 may be captured in signals raised by sensors 450. For instance, each strain sensor may sense pressure. And in examples where sensors 450 comprise an array of multiple sensors, the array of sensors may sense direction and/or velocity of physical contact between wiper 454 and the sensor array. Additionally, physical contact with a predetermined spatial and/or temporal sequence of sensors 450 of the array may also be detected. Accordingly, servicing mechanism 452 may be operated deliberately to cause predefined mechanical interaction between wiper 454 and sensors 450. Put another way, mechanical interaction between wiper 454 and sensor(s) 450 may be modulated, e.g., by electronic controller 220 or other “off-die” logic, in order to encode information into the signal(s) raised by sensor(s) 450.

FIG. 4B depicts one non-limiting example of how a plurality of strain sensors 450 may be deployed at a plurality of locations on fluid ejection die 402 of fluid ejection device 404. Whereas FIG. 4A was a view from the side of an example fluid ejection device 404, FIG. 4B is a view towards at surface 456 of fluid ejection die 402. In FIG. 4B, there are sixty-nine strain sensors 450 distributed across fluid ejection die 402. In various examples, predefined spatial and/or temporal sequences of some or all of these strain sensors may be physically contacted, e.g., using wiper 454 of servicing mechanism 452, in order to encode information.

Examples described herein primarily relate to fluid ejection dies such as printhead dies equipped with sensors, with techniques described herein being performed to encode information into on-die memory. However, this is not meant to be limiting. In various examples, other components installed into a printing system, such as a fluid ejection device 404 (e.g., a printhead) or a printbar 202, may include sensors that can be mechanically interacted with in order to encode information.

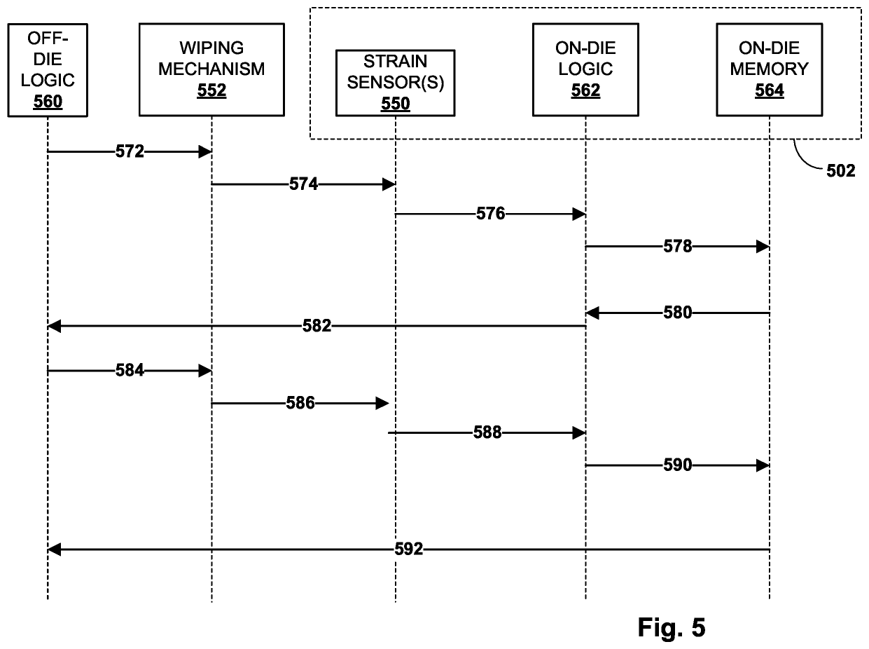

FIG. 5 schematically depicts an example of how information may be encoded onto a fluid ejection die 502 configured with selected aspects of the present disclosure. FIG. 5 depicts, at top left, off-die logic 560 that may include, for instance, electronic controller 220 or even host 222 of FIG. 2. FIG. 5 further depicts a servicing mechanism 552, which may be similar to or different from servicing mechanism 452 in FIG. 4A.

Fluid ejection die 502 in FIG. 5 includes strain sensor(s) 550, on-die logic 562, and on-die memory 564 operably coupled with on-die logic 562. On-die logic 562 may take various forms, such as state machine logic integrated into the die itself and/or into a component of the die. On-die memory 564 may take various forms as well, including but not limited to volatile memory, non-volatile memory, electrically erasable programmable read-only memory (“EEPROM”), flash memory, etc.

In some examples information may be stored in on-die memory 564 as follows. At 572, off-die logic 560 may send command(s) to servicing mechanism 552. These commands may be sent using wireless or wired communication channels, such as a bus, control lines 226 in FIG. 2, etc., and may include a predetermined sequence of numbers, characters, and/or symbols.

At 574, servicing mechanism 552 may mechanically interact with strain sensor(s) 550 of fluid ejection die 502. This mechanical interaction may be modulated in accordance with the command(s) of 572 in order to convey the predetermined sequence of numbers, characters, and/or symbols.

As a non-limiting example, suppose eight of the sensors 450 in FIG. 4B correspond to an eight-digit binary number, XXXX XXXX, which is stored in memory (e.g., 564) as a byte of data. Each digit of the binary number may either be zero or one. Suppose further that the default state of each digit is zero, so that the binary number is 0000 0000. Now, suppose operation of servicing mechanism 552 is modulated at 574 so that physical contact is made with sensors 450 representing the last three digits. This may toggle those digits to ones, resulting in a binary number of 0000 0111, or seven in the decimal system.

Referring back to FIG. 5, at 576, strain sensor(s) 550 raise signal(s) in response to the mechanical interaction of 574. These signal(s) at 574 may be analyzed by on-die logic 562 to extract the information encoded into the sensor signal(s) via the mechanical interaction of 574. In the example of the previous paragraph, for instance, the extracted information would be 0000 0111. At 578, the extracted information may be stored in on-die memory 564 by on-die logic 562. Subsequently, at 580, on-die logic 562 may read the information from on-die memory 564, and at 582 may provide the information to off-die logic 560, e.g., to confirm proper operation of strain sensor(s) 550.

The data transfer of 582 may occur using, for instance, control line(s) 226, which may be considered “in-band.” By contrast, the data transfer of 574 occurs mechanically, and therefore may be considered “out-of-band” for purposes of the present disclosure. Data transferred out-of-band may be more difficult to intercept than data transferred in-band, and therefore may be considered more secure.

In some examples, the printing system in which fluid ejection die 502 is installed may store another piece of information, which may be referred to herein as an operational verification code, or “OVC.” The OVC may be used by the printing system, for instance, to confirm the type of fluid ejection die 502 that is installed. In some examples, nozzles of fluid ejection die 502 may be addressed, and the addresses may be scrambled based on the OVC. Because off-die logic 560 “knows” the OVC code, it is able to send properly addressed nozzle data to fluid ejection die 502.

In some examples, if the OVC is not available and/or cannot be confirmed by on-die logic 562, the printing system may raise output (e.g., audibly, visually on an electronic display or using light emitting diode(s) on the printer, etc.) notifying a user that the type of installed fluid ejection die is unknown. Additionally or alternatively, the printing system may operate an “unknown” fluid ejection die 502 in a “protected” or “untrusted” state in which fluid ejection die 502 is operated and/or utilized at a slower speed and/or with less power, etc.

Referring back to FIG. 5, at 584-590, off-die logic 560 may cause the OVC to be conveyed to fluid ejection die 502 and written into on-die memory 564, similar to 572-578. In some examples, at 592, on-die logic 562 may verify the OVC, e.g., by comparing it to a known lookup table of valid OVC's, and may transmit data indicative of the verification to off-die logic 560. Notably, the OVC is not transferred back to off-die logic 560. Accordingly, in this example, the OVC is transferred out-of-band, rather than in-band. Consequently, and as noted previously, it may be difficult to intercept the OVC.

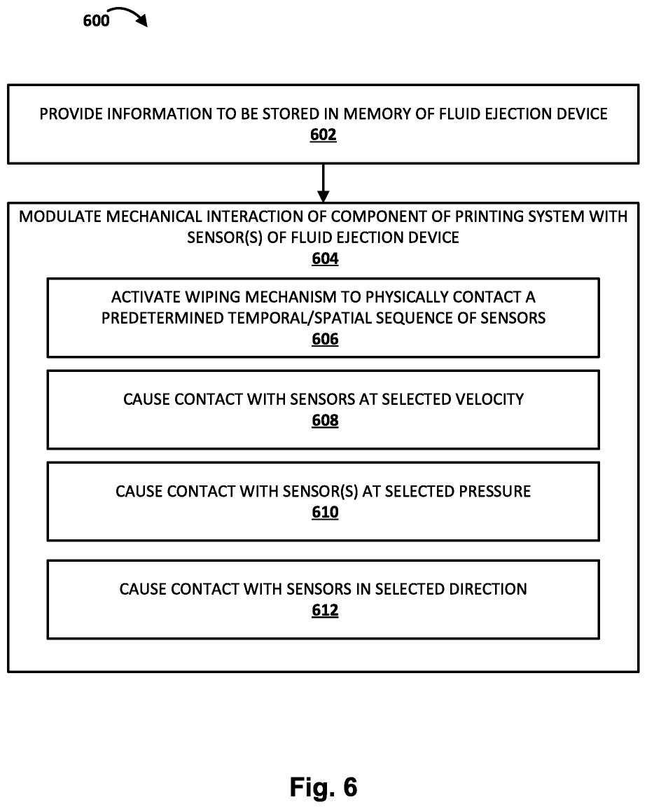

FIG. 6 illustrates a flowchart of an example method 600 for controlling an interaction between a fluid ejection die configured with selected aspects of the present disclosure and a printing system configured with selected aspects of the present disclosure. Other implementations may include additional operations than those illustrated in FIG. 6, may perform operations (s) of FIG. 6 in a different order and/or in parallel, and/or may omit various operations of FIG. 6.

At block 602, information to be stored in memory of a fluid ejection die such as 302, 402, 502 may be provided. For example, an OVC or other identifier, which may be numeric, alpha-numeric, any combination of numbers/letters/symbols, a binary or hexadecimal value, or any other computer-readable value, may be determined by a printing system such as 100, 200.

At block 604, a logic device such as electronic controller 220 and/or off-die logic 560 may modulate mechanical interaction of a component such as servicing mechanism 452, 552 with a sensor such as sensor(s) 450, 550 of a fluid ejection die 302, 402, 502. The modulated mechanical interaction may cause the sensor to generate a signal that conveys the information. Additionally, the information conveyed in the signal may be written, e.g., by on-die logic 562, into the memory of the fluid ejection die, such as on-die memory 564.

This modulation of block 604 may be performed in various ways in accordance with the information provided at block 602. In some examples, at block 606, the servicing mechanism may be activated to physically contact, or cause physical contact with, a predetermined temporal and/or spatial sequence of sensors on a fluid ejection die.

Additionally or alternatively, in some examples, the physical contact between the printing system component and an array of sensors may be modulated. For example, at block 608, the printing system may cause a wiper 454 to contact the sensor array at a selected velocity. For example, one velocity (e.g., slow) may correspond to a first value, and another velocity (e.g., fast) may correspond to another value, etc.

As another example, at block 610, the system may cause the wiper 454 to contact the sensor 450 with a selected amount of pressure. For example, pressure below a first threshold may represent one value, pressure above the first threshold but below a second threshold may represent a second value, and so on.

As yet another example, at block 612, the printing system may cause the wiper 454 to contact a sensor array in a selected direction. For example, wiping a sensor array from left-to-right may cause the sensor array to raise a signal indicative of a first value, and wiping the sensor array from right-to-left may cause the sensor array to raise a signal indicative of a second value. Of course, the examples of modulated mechanical interaction of blocks 606-612 are not meant to be limiting, and other examples are possible.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. A fluid ejection die, comprising:
a sensor to detect mechanical force imposed by a system in which the fluid ejection die is installed;
memory; and
logic operably coupled with the sensor and the memory, wherein the logic is to:
extract information from a signal raised by the sensor, wherein the information is encoded into the signal via mechanical interaction between a component of the system and the sensor, wherein the mechanical interaction is modulated by the system to encode the information; and
store the information in the memory.

2. The fluid ejection die of claim 1, wherein the sensor comprises a strain sensor.

3. The fluid ejection die of claim 2, wherein the component of the system comprises a servicing mechanism, and the mechanical interaction includes cleaning of the fluid ejection die by the servicing mechanism.

4. The fluid ejection die of claim 1, wherein the component of the system comprises a printhead cap, and the mechanical interaction includes sealing of a nozzle with the printhead cap.

5. The fluid ejection die of claim 3, wherein the sensor comprises a sensor array, and the mechanical interaction comprises a direction or velocity of the wiping across the sensor array.

6. The fluid ejection die of claim 3, wherein the mechanical interaction comprises a pressure of the wiping on the sensor.

7. The fluid ejection die of claim 1, wherein the sensor comprises a plurality of sensors distributed at a plurality of locations of the fluid ejection die.

8. The fluid ejection die of claim 7, wherein the information is modulated into the mechanical interaction via mechanical interaction of the component of the system with a spatial or temporal sequence of the plurality of sensors.

9. A fluid ejection system comprising:
a controller; and
a component operably coupled with the controller, wherein the controller operates the component to cause the component to mechanically interact with a sensor of a fluid ejection die installed in the fluid ejection system;
wherein the controller is to modulate mechanical interaction of the component with the sensor in accordance with information to be stored in memory of the fluid ejection die.

10. The fluid ejection system of claim 9, wherein the to be modulated mechanical interaction is to cause the sensor to raise a signal encoded with the information, and wherein the information encoded in the signal is to be written into the memory of the fluid ejection die.

11. The fluid ejection system of claim 9, wherein the component comprises a servicing mechanism, and the mechanical interaction comprises wiping of the fluid ejection die using the servicing mechanism.

12. The fluid ejection system of claim 11, wherein the sensor comprises a sensor array, and the mechanical interaction comprises:
a direction of the wiping across the sensor array;
a velocity of the wiping across the sensor array;
a pressure of the wiping on the sensor; or
a combination thereof.

13. A method comprising:
providing information to be stored in memory of a fluid ejection die; and
modulating mechanical interaction of a component of a system with a sensor of the fluid ejection die in accordance with the information to be stored in the memory of the fluid ejection die;
wherein the modulated mechanical interaction causes the sensor to generate a signal that conveys the information, and wherein the information conveyed in the signal is written into the memory of the fluid ejection die.

14. The method of claim 13, wherein the sensor comprises a strain sensor.

15. The method of claim 13, wherein the component of the system comprises a servicing mechanism, and the mechanical interaction comprises servicing of the fluid ejection die using the servicing mechanism.
